(19) United States
(12) Patent Application Publication
(10) Pub. No.: US 2012/0151423 A1
(43) Pub. Date: Jun. 14, 2012

(54) LARGE SCALE FORMAL ANALYSIS BY STRUCTURAL PREPROCESSING

(75) Inventors: Jason R. Baumgartner, Austin, TX (US); Tilman Gloekler, Gaertringen (DE); Christoph Jaeschke, Tuebingen (DE); Ralf Ludewig, Schoenaich (DE)

(73) Assignee: International Business Machines Corporation, Armonk, NY (US)

(21) Appl. No.: 13/284,489

(22) Filed: Oct. 28, 2011

(30) Foreign Application Priority Data
Dec. 13, 2010 (EP) 10194661

(51) Int. Cl. G06F 17/50

(52) U.S. Cl. 716/107

(57) ABSTRACT

An improved method for performing a formal verification of a property in an electronic circuit design comprises: specifying at least one safety property in the electronic circuit design at a register-transfer level, setting boundaries of a logic cone to a start level according to a configurable structural design criterion, extracting the logic cone from the electronic circuit design based on the at least one specified safety property and the set boundaries, executing a formal verification tool on the logic cone to verify the at least one specified property, extending the boundary of the logic cone according to a configurable structural design criterion and performing the extracting and executing on the new logic cone, if the verification result does not satisfy the at least one safety property.

### CROSS-REFERENCE TO RELATED APPLICATIONS

This application claims priority under 35 U.S.C. §119 to European patent application EP10194661, filed Dec. 13, 2010, the disclosure of which is incorporated herein by reference.

### BACKGROUND

The inventive subject matter relates in general to the field of hardware circuit verification, and in particular to a method for performing a formal verification of a property in an electronic circuit design and test equipment for performing a formal verification of a property in an electronic circuit design. Still more particularly, the inventive subject matter relates to a data processing program and a computer program product for performing a formal verification of a property in an electronic circuit design.

### DESCRIPTION OF THE RELATED ART

Traditionally, hardware circuit verification is performed using a combination of simulation and formal techniques often with a strong preference for simulation, because simulation is well known to be applicable to even very complex designs. A drawback of simulation-based approaches is limited coverage, as only a limited number of scenarios can typically be simulated. State-of-the-art formal verification techniques often suffer because of scalability issues when used for large scale applications, which can result in excessive run times and/or memory consumption. On the other hand, formal techniques are able to cover the complete state space without omissions and, thus, result in an optimum coverage.

An objective of hardware verification done with formal, semi-formal, or simulation test benches is to ensure that the “device-under-verification” (DUV) behaves as specified for a well-defined set of input sequences. The typical setup for testing such behavior, either with simulation or by using formal techniques, comprises a test bench with constrained drivers allowing for a modeling of the environment and its constraints by driving valid sequences of input stimuli. Non-deterministic drivers allow a formal definition of a set of valid input sequences and scenarios. Hence, simulation is only able to cover a subset of these sequences, if the number of possible scenarios is sufficiently large.

In contrast, formal techniques—provided that they are applicable to a design—allow a verification of the device-under-verification (DUV) for the whole set of possible input stimuli. Normally, checker tools are used to define the interesting properties of the device-under-verification output signals or internal signals that are expected to be verified. The main issue preventing the wide-spread application of formal techniques for verification is scalability of the design size, which results in excessive runtimes and memory consumption, if applied to overly complex problems. Excessive memory consumption is typically caused by the internal representation of the verification problem, e.g., by using binary decision diagrams (BDDs) or similar representations.

### SUMMARY

Example embodiments disclosed herein provide a method and test equipment for performing a formal verification of a property in an electronic circuit design, which are able to perform formal verification for large scale designs and maximize quality of verification results due to high coverage.

Accordingly, in one embodiment a method for performing a formal verification of a property in an electronic circuit design comprises specifying at least one safety property for the electronic circuit design at a register-transfer level, setting boundaries of a logic cone to a start level according to a configurable structural design criterion, extracting the logic cone from the electronic circuit design based on the at least one specified safety property and the set boundaries, executing a formal verification tool on the logic cone to verify the at least one specified safety property, extending the boundary of the logic cone according to a configurable structural design criterion and performing the extracting and executing again on the new logic cone, if the verification result does not satisfy the at least one safety property.

In additional embodiments, the extending the boundary of the logic cone according to the configurable structural criterion and performing the extracting and executing again on the new logic cone, if the verification result does not satisfy the at least one safety property, are repeated until the verification result does satisfy the at least one safety property or the formal verification tool exhausts a configurable resource limit. Satisfying a safety property in this context refers to the fact of proving that a certain property has been proven correct.

In further embodiments, during the extraction of the logic cone a number of properties are reduced by identifying and removing extraneous properties.

In further embodiments, constrained or unconstrained random drivers are inserted to execute the formal verification tool.

In further embodiments, during the extraction of the logic cone from the electronic circuit design a structural analysis is executed, wherein a traversed net list is generated containing at least one of the following: safety properties, signals, logical operators, latches, and registers.

In further embodiments, during the extraction of the logic cone from the electronic circuit design logic circuits that are irrelevant to the at least one specified safety property are removed.

In further embodiments, the boundaries of the logic cone correspond to at least one of the following: a logic layer or a latch layer.

In another embodiment, a test equipment for performing a formal verification of a property in an electronic circuit design comprises an input/output device used to specify at least one safety property for the electronic circuit design at a register-transfer level, and to set boundaries of a logic cone to a start level according to a configurable structural design criterion, structural analysis means to extract the logic cone from the electronic circuit design based on the specified safety property and the set boundaries, a formal verification tool to verify the at least one specified safety property on the extracted logic cone, wherein the structural analysis means extend the boundaries of the logic cone according to a configurable structural design criterion and extracts again a new logical cone from the electronic circuit design based on the specified safety property and the new boundaries, if the verification result does not satisfy the specified safety property, and the formal verification tool verifies again the specified safety property on the extracted new logical cone.

In further embodiments, the extending the boundary of the logic cone according to the configurable structural design criterion and performing the extracting and executing again on the new logic cone, if the verification result does not satisfy the at least one safety property, are repeated until the verification result does satisfy the at least one safety property or the formal verification tool exhausts a configurable resource limit.

In further embodiments, constrained or unconstrained random drivers are inserted to execute the formal verification tool.

In further embodiments, the structural analysis means reduces a number of properties by identifying and removing extraneous properties.

In further embodiments, the structural analysis means generates a traversed net list containing at least one of the following: safety properties, signals, logical operators, latches, registers, and removes logic circuits from the electronic circuit design that are irrelevant to the specified signal property.

In another embodiment, a data processing program for execution in a data processing system comprises software code portions to perform a method for performing a formal verification of a property in an electronic circuit design when the program is run on the data processing system.

In yet another embodiment, a computer program product stored on a computer-usable medium, comprises computer-readable program means for causing a computer to perform a method for performing a formal verification of a property in an electronic circuit design when the program is run on the computer.

Therefore, embodiments disclosed herein extend the capabilities of traditional formal verification approaches that rely on semantic analysis-based abstractions, by adding structural preprocessing before the traditional formal verification algorithms are run. This preprocessing scales gracefully with the design complexity and allows for a significant reduction of the problem size in order to speed up the subsequent formal verification algorithms and also to reduce memory consumption. This reduction may be possible with state-of-the-art semantic analysis-based abstractions, however not without the cost of a significantly lower performance and excessive computational requirements, which often prevents a wide-spread usage of these algorithms for complex verification problems.

As such, embodiments disclosed herein simplify the device-under-verification logic before translating it to a representation of the verification problem which is analyzed by a formal verification tool. This advantageously allows for speeding up the formal verification algorithms and reducing memory requirements. In order to achieve this device-under-verification logic simplification, embodiments disclosed herein propose an additional structural analysis and pruning that is orders of magnitude less computationally expensive than traditional semantic analysis-based abstraction algorithms and that scales well with the design complexity.

This structural optimization can reduce the overall problem size by reducing the number of properties to solve, which is achieved by identifying extraneous properties and removing them and/or reduce the problem size by removing logic that is irrelevant to the specified properties, wherein only safety properties are specified, which state that something undesirable likely never happens—that is, that the design under verification likely does not enter an unacceptable state. In particular, extraneous properties refer to properties which are not “adequately” contained in the logic selected for the at least one selected safety property. The term “adequately” here is further defined, e.g., to refer to safety properties which are comprised within the logic selected for the at least one selected safety property; to refer to safety properties expressed as logic over latches and registers comprised within the logic selected for the at least one selected safety property; or to refer to safety properties whose inclusion adds at most a configurable amount of logic to that already comprised within the logic selected for the at least one selected safety property.

### BRIEF DESCRIPTION OF THE DRAWINGS

An example embodiment, as described in detail below, is shown in the drawings, in which:

FIG. 1 is a schematic block diagram of test equipment for performing a formal verification of a property in an electronic circuit design, in accordance with an example embodiment;

FIG. 2 is a schematic flow diagram of a method for performing a formal verification of a property in an electronic circuit design, in accordance with an example embodiment;

FIG. 3 is a schematic block diagram showing a simplified electronic circuit design after specifying a safety property of the electronic design, in accordance with an example embodiment;

FIG. 4 is a schematic block diagram showing the simplified electronic circuit design of FIG. 3 after setting boundaries of a logic cone to a start level, in accordance with an example embodiment; and

FIG. 5 is a schematic block diagram showing the simplified electronic circuit design of FIG. 3 after increasing the set boundaries of the logic cone to a higher level, in accordance with an example embodiment.

### DESCRIPTION OF EMBODIMENT(S)

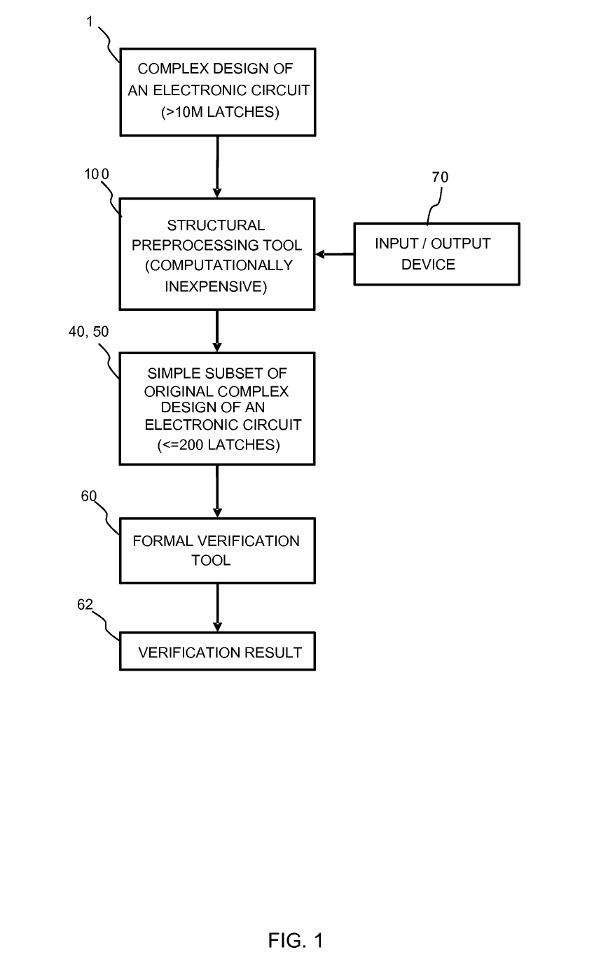

FIG. 1 is a schematic block diagram of test equipment for performing a formal verification of a property in an electronic circuit design 1, in accordance with an example embodiment.

Referring to FIG. 1, the illustrated embodiment employs test equipment for performing a formal verification of a property in a complex electronic circuit design 1, which may, for example, comprise more than 10 million latches. The test equipment comprises a formal verification tool 60, an input/output device 70, and structural analysis means 100, which are used to run a structural preprocessing tool to simplify the complex electronic circuit design 1. The input/output device 70 is used to specify at least one safety property in the electronic circuit design 1 at a register-transfer level, and to set boundaries of a logic cone 40 to a start level according to a configurable structural design criterion. A safety property is defined as state that something undesirable likely never happens, e.g., that the design under test likely does not enter an unacceptable state. The structural analysis means 100 extracts the logic cone 40 from the electronic circuit design 1 based on the specified safety property and the set boundaries. Thus, the extracted logic cone 40 represents a simple subset of the original complex electronic circuit design 1 comprising 200 or less latches. The formal verification tool 60 is used to verify the at least one specified safety property on the extracted logic cone 40 and to output a verification result 62.

If the verification result 62 is not fulfilling the specified safety property the structural analysis means 100 extend the boundaries of the logic cone 40 according to the configurable structural design criterion, and extracts a new logical cone 50 from the complex electronic circuit design 1 based on the specified safety property and the new boundaries. The formal verification tool 60 then verifies again the specified safety property on the extracted new logical cone 50.

The structural analysis 100 is executed, for example, as described in “Strukturelle Verifikation mittels parser-gesteuerter Netzlisten-Traversierung”, published February 2010 at “Methoden und Beschreibungssprachen zur Modellierung und Verifikation von Schaltungen and Systemen” in Dresden, Germany, which is hereby incorporated by reference in its entirety. The input to the structural analysis 100 is the current input nets of the current logic cone 40. For the first enlargement, the nets on which the safety properties 10 are defined can be taken as the input to the structural analysis 100. The structural analysis 100 then traverses the netlist in backward signal direction using the configurable structural criterion in the form of a grammar as described in the above mentioned state of the art paper. The configurable structural criterion allows for referencing of all properties accessible in the netlist structure. The properties accessible are the type of logic, latch, or register, and the name of the net. The configurable structural criterion is specified by a number of stop-rules. The stop-rules are a conjunction of regular expressions on the textual representation of available netlist properties. The configurable structural criterion is checked at each net which is traversed in backward direction during the structural analysis 100. As described in the above mentioned paper, a grammar is selecting the active stop-rules during traversal. The active stop-rules may cause the traversal to stop. The grammar specifies if a stop defines the input of the new logic cone 50, or if the traversal will continue using a new set of active stop-rules.

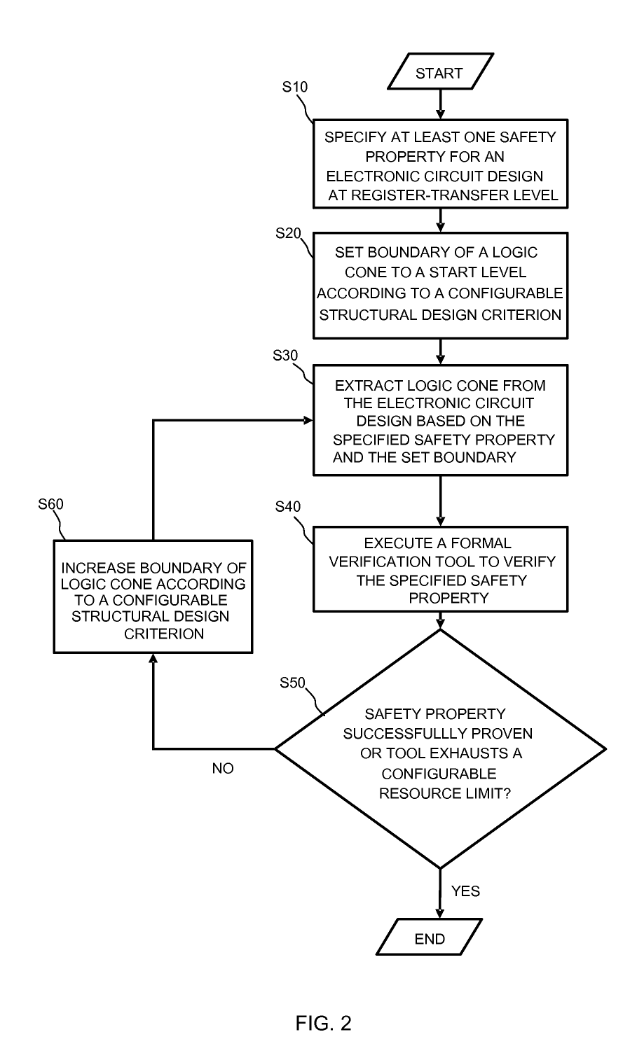

FIG. 2 is a schematic flow diagram of a method for performing a formal verification of a property in an electronic circuit design 1, in accordance with an example embodiment.

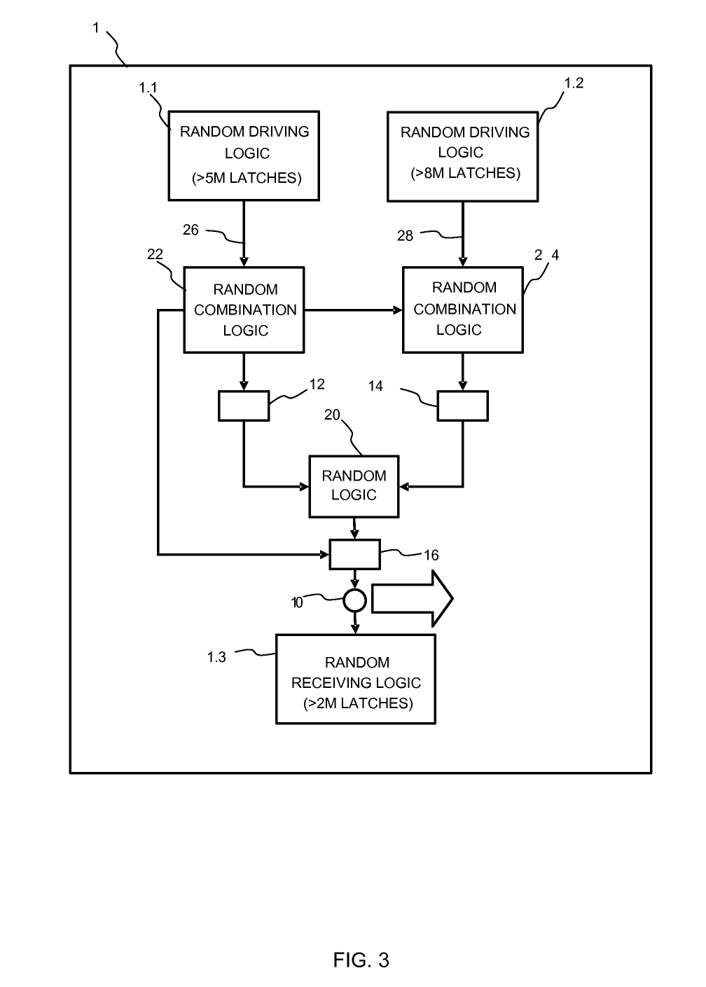

Referring to FIG. 2, the illustrated embodiment of a method for performing a formal verification of a property 10 for a signal in a design 1 specifies in S10 at least one safety property 10 for the electronic circuit design 1 at a register-transfer level. FIG. 3 shows a simplified version of the electronic circuit design 1 after specifying the safety property 10 of the electronic circuit design. Referring to FIG. 3, the simplified version of the electronic circuit design 1 comprises a first random driving logic 1.1 with less than 5 Million latches, for example, driving a first primary input signal 26 for a first random combination logic 22, a second random driving logic 1.2 with less than 8 Million latches, for example, driving a second primary input signal 28 for a second random combination logic 24, and a random receiving logic 1.3 with less than 2 Million latches, for example. In the illustrated embodiment an output of the first random combination logic 22 is fed to a first register 12, and an output of the second random combination logic 24 is fed to a second register 16. The outputs of both registers 12, 14 are fed to a random logic 20. The output of the random logic 20 is fed to a third register 16. The output of the third register 16 is fed to the random receiving logic 1.3 and represents the specified safety property 10.

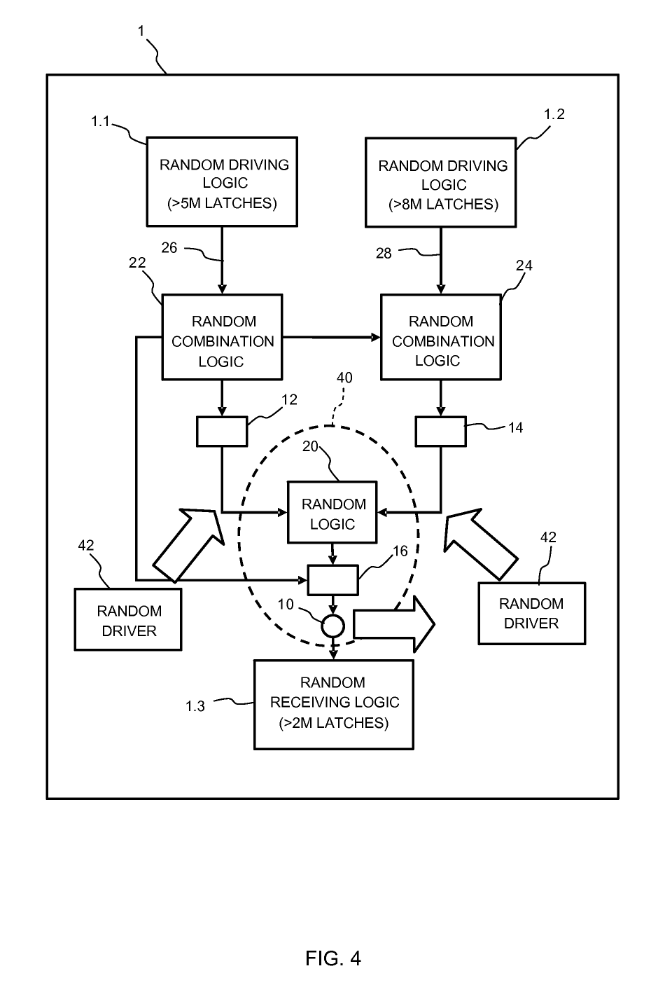

Referring again to FIG. 2, in S20 boundaries of a logic cone 40 are set to a start level according to a configurable structural design criterion, and in S30 the logic cone 40 is extracted from the electronic circuit design 1 based on the at least one specified safety property 10 and the set boundaries. FIG. 4 shows the simplified electronic circuit design of FIG. 3 after setting boundaries of the logic cone 40 to the start level, wherein the logic cone 40 is represented by a dashed line. In S40 a formal verification tool 60 is executed on the logic cone 40 to verify the at least one specified property 10. To execute the formal verification tool 60, constrained or unconstrained random drivers 42 are inserted at the boundaries of the logic cone to drive the components inside the logical cone 40. One manner of inserting the unconstrained random drivers 42 is to disconnect the connection between the outputs of the registers 12 and 14 and the corresponding inputs of the random logic 20, thus, these open inputs may now correspond to unconstrained primary inputs of the modified circuit. Alternatively, if certain “constraints” are known or may be derived over the disconnected gates, e.g., that they encode a one-hot condition such that exactly one of them may evaluate to a local “one” vs. “zero” value at any time, logic which encodes such constraints may be directly synthesized re-connect to the disconnected logic.

During S50 it is determined if the verification result 62 satisfies the at least one safety property 10. It might also be the case that the verification tool 60 exceeds configurable resource bounds, e.g., time or memory limits. If the latter occurs, the verification problem may not be able to be solved by the proposed algorithms and means.

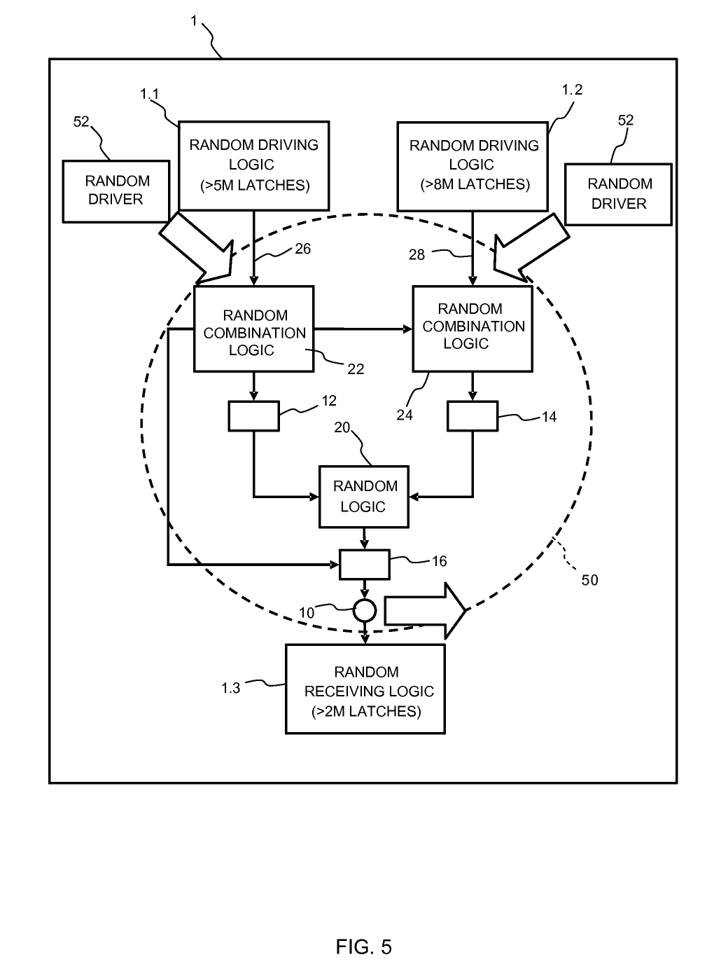

If the verification result 62 does not satisfy the at least one safety property 10, the boundary of the logic cone 40 is extended and the extracting and executing S30 and S40 are repeated with the new logic cone 50. FIG. 5 shows the simplified electronic circuit design of FIG. 3 after extending the set boundaries of the logic cone 40, wherein the new logic cone 50 is also represented by a dashed line. To execute the formal verification tool 60 on the new logic cone 50 in S40 new constrained or unconstrained random drivers 52, 54 are inserted at the boundaries of the new logic cone 50 to drive the components inside the new logical cone 50. This inner loop comprising S30 to S60 is repeated until the verification result 62 satisfies the at least one safety property 10 or the verification tool 60 exhausts a configurable resource limit. One manner of inserting the unconstrained random drivers 52 is to disconnect the signal between the outputs of the random driving logics 1.1 and 1.2 and the corresponding inputs of the random combination logics 22 and 24. Constrained drivers may be inserted by synthesizing logic adhering to the constraints to re-connect to said disconnected signals. The boundaries of the logic cones 40, 50 correspond preferably to a logic layer and/or to a latch layer.

During the extracting S30 of the logic cones 40, 50 the structural analysis means 100 reduces a number of properties by identifying and removing extraneous properties. Furthermore, the structural analysis means 100 generates a traversed net list during the extracting S30 of the logic cones 40, 50 containing safety properties 10, signals 26, 28, logical operators, latches and/or registers 12, 14, 16, and removes logic circuits from the electronic circuit design 1 that are irrelevant to the specified signal property 10.

The described structural optimization can reduce the overall problem size by reducing the number of properties to solve, which is achieved by identifying extraneous properties and removing them and/or reducing the problem size by removing logic that is irrelevant to the specified properties. The result of this optimization is a reduced complexity of the overall verification problem in terms of the number of properties to solve and/or the logic complexity. Formal semantic analysis-based abstraction can then be applied to the reduced problem instead of simulation, which significantly increases the quality of results of the verification process.

The disclosed method for performing a formal verification of a property in an electronic circuit design can be implemented as an entirely software embodiment, or an embodiment containing both hardware and software elements. In an example embodiment, the inventive subject matter is implemented in software, which includes but is not limited to firmware, resident software, microcode, etc.

Furthermore, the inventive subject matter can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for performing a formal verification of a property in an electronic circuit design, comprising:
specifying at least one safety property for said electronic circuit design at a register-transfer level,
setting boundaries of a logic cone to a start level according to a configurable structural design criterion,
extracting said logic cone from said electronic circuit design based on said at least one specified safety property and said set boundaries,
executing a formal verification tool on said logic cone to verify said at least one specified safety property, and
extending said boundary of said logic cone according to a configurable structural design criterion and performing said extracting and executing again on said new logic cone, if said verification result does not satisfy said at least one safety property.

2. The method of claim 1, wherein the extending said boundary of said logic cone according to said configurable structural design criterion and performing said extracting and executing again on said new logic cone, if said verification result does not satisfy said at least one safety property, are repeated until said verification result does satisfy said at least one safety property or said formal verification tool exhausts a configurable resource limit.

3. The method of claim 1, wherein during said extracting of said logic cone a number of properties is reduced by identifying and removing extraneous properties.

4. The method of claim 1, wherein constrained or unconstrained random drivers are inserted to execute said formal verification tool.

5. The method of claim 1, wherein during said extracting of said logic cone from said electronic circuit design a structural analysis is executed, wherein a traversed net list is generated containing at least one of the following: safety properties, signals, logical operators, latches, or registers.

6. The method of claim 1, wherein during said extracting of said logic cone from said electronic circuit design, logic circuits that are irrelevant to said at least one specified safety property are removed.

7. The method of claim 1, wherein said boundaries of said logic cone correspond to at least to one of the following: a logic layer or a latch layer.

8. A test equipment apparatus for performing a formal verification of a property in a electronic circuit design, comprising
an input/output device used to specify at least one safety property for said electronic circuit design at a register-transfer level, and to set boundaries of a logic cone to a start level according to a configurable structural design criterion,
structural analysis means to extract said logic cone from said electronic circuit design based on said specified safety property and said set boundaries,
a formal verification tool to verify said at least one specified safety property on said extracted logic cone,
wherein said structural analysis means extends said boundaries of said logic cone according to a configurable structural design criterion and extracts again a new logical cone from said electronic circuit design based on said specified safety property and said new boundaries, if said verification result does not satisfy said specified safety property, and
wherein said formal verification tool verifies again said specified safety property on said extracted new logical cone.

9. The test equipment apparatus of claim 8, wherein said structural analysis means said extending said boundary of said logic cone according to said configurable structural design criterion and performing said extraction and verification again on said new logic cone, if said verification result does not satisfy said at least one safety property, are repeated until said verification result does satisfy said at least one safety property or said formal verification tool exhausts a configurable resource limit.

10. The test equipment apparatus of claim 8, comprising means to insert constrained or unconstrained random drivers to execute said formal verification tool.

11. The test equipment apparatus of claim 8, wherein said structural analysis means reduces a number of properties by identifying and removing extraneous properties.

12. The test equipment apparatus of claim 8, wherein said structural analysis means generates a traversed net list containing at least one of the following: safety properties, signals, logical operators, latches, or registers, and removes logic circuits from said electronic circuit design that are irrelevant to said specified signal property.

13. A data processing program for execution in a data processing system comprising software code portions for performing a formal verification of a property in an electronic circuit design, said data processing program configured to:
specify at least one safety property for said electronic circuit design at a register-transfer level,
set boundaries of a logic cone to a start level according to a configurable structural design criterion,
extract said logic cone from said electronic circuit design based on said at least one specified safety property and said set boundaries,
execute a formal verification tool on said logic cone to verify said at least one specified safety property, and
extend said boundary of said logic cone according to a configurable structural design criterion and perform said extraction and execution again on said new logic cone, if said verification result does not satisfy said at least one safety property.

14. The data processing program of claim 13, wherein the extension of said boundary of said logic cone according to said configurable structural design criterion and performance of said extraction and execution again on said new logic cone, if said verification result does not satisfy said at least one safety property, are repeated until said verification result does satisfy said at least one safety property or said formal verification tool exhausts a configurable resource limit.

15. The data processing program of claim 13, wherein during said extraction of said logic cone a number of properties is reduced by identification and removal of extraneous properties.

16. The data processing program of claim 13, wherein constrained or unconstrained random drivers are inserted to execute said formal verification tool.

17. The data processing program of claim 13, wherein during said extraction of said logic cone from said electronic circuit design a structural analysis is executed, wherein a traversed net list is generated containing at least one of the following: safety properties, signals, logical operators, latches, or registers.

18. A computer program product stored on a computer-usable medium, comprising computer-readable instructions for causing a computer to perform a formal verification of a property in an electronic circuit design, said computer program product configured to:
specify at least one safety property for said electronic circuit design at a register-transfer level,
set boundaries of a logic cone to a start level according to a configurable structural design criterion,
extract said logic cone from said electronic circuit design based on said at least one specified safety property and said set boundaries,
execute a formal verification tool on said logic cone to verify said at least one specified safety property, and
extend said boundary of said logic cone according to a configurable structural design criterion and perform said extraction and execution again on said new logic cone, if said verification result does not satisfy said at least one safety property.

19. The computer program product of claim 18, wherein the extension of said boundary of said logic cone according to said configurable structural design criterion and performance of said extraction and execution again on said new logic cone, if said verification result does not satisfy said at least one safety property, are repeated until said verification result does satisfy said at least one safety property or said formal verification tool exhausts a configurable resource limit.

20. The computer program product of claim 18, wherein during said extraction of said logic cone a number of properties is reduced by identification and removal of extraneous properties.

21. The computer program product of claim 18, wherein constrained or unconstrained random drivers are inserted to execute said formal verification tool.

22. The computer program product of claim 18, wherein during said extraction of said logic cone from said electronic circuit design a structural analysis is executed, wherein a traversed net list is generated containing at least one of the following: safety properties, signals, logical operators, latches, or registers.
